(19) United States
(12) Patent Application Publication
(10) Pub. No.: US 2008/0221749 A1
(43) Pub. Date: Sep. 11, 2008

(54) Diagnostic Interface for Applications on a Service Gateway

(75) Inventors: Gerrit De Boer, Hildesheim (DE); Wolfgang Kopmann, Hildesheim (DE); Peter Engel, Hildesheim (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/791,069

(22) PCT Filed: Sep. 20, 2005
(86) PCT No.: PCT/EP05/54675

§ 371 Date: May 13, 2008

(30) Foreign Application Priority Data
Nov. 18, 2004 (DE) 10 2004 055 573.7

(51) Int. Cl. G06F 17/00

(52) U.S. Cl. 701/33; 701/29

(57) ABSTRACT

A method for supplying internal information relevant for performing a diagnosis, of an application available in a vehicle and running on a service gateway, in which a defined uniform application diagnostic interface, via which communication with the service gateway is made possible, is provided in the application.

### FIELD OF THE INVENTION

The present invention relates to a method and a system for supplying internal information, relevant for performing a diagnosis, of an application available in a vehicle and running on a service gateway. Furthermore, the present invention relates to a computer program and a corresponding computer program product.

### BACKGROUND INFORMATION

The number of functions implemented with the help of software in vehicles is increasing steadily. Technologies that allow administration and/or management of the software components being used during operation of a vehicle are becoming increasingly interesting. These also include a so-called remote diagnosis during which the vehicle is accessed from an external infrastructure such as the Internet and a diagnosis is made by a remote query.

So-called service gateway systems, also referred to below as SGS, are known for general access to applications available in a vehicle. An Open Service Gateway system for home and telematics use is currently standardized in the so-called OSGi (Open Service Gateway initiative).

In general, an SGS is a system made up of one or more so-called service gateways, also known as SG for short, and a so-called gateway operator, also known as a GO.

A service gateway includes an application frame and is also equipped with certain basic functions. The basic functions of a service gateway include, for example, configuration management, a so-called life-cycle management, and user management. In general a service gateway is platform-independent, i.e., it runs in a Java run-time environment, for example. Furthermore, a service gateway is dynamically configurable and dynamically expandable to include software components. In most cases, a service gateway is also able to communicate with electronic components networked with the service gateway in some way. The electronic components may be, for example, Java-based components or other modules. The modules may be addressed with dedicated drivers, for example.

A gateway operator in general is responsible for the administration of one or more service gateways and for providing and mediating services for the corresponding service gateways in a controlled manner. This is understood to include, for example, a so-called download, activation, deactivation and update/upgrade of applications on a corresponding service gateway.

Such a service gateway system allows access to a so-called client having a service gateway. The access may be local or remote. Such accessing of a client is generally performed with the goal of managing components such as applications and modules of the client. Furthermore, access is for the purpose of monitoring and providing services and applications. When using such service gateway systems for maintenance of vehicles, the corresponding service gateway is usually inside the vehicle and the associated gateway operator is in an external infrastructure. This service gateway may be, for example, a multimedia terminal in the vehicle. The gateway operator may be located on a server of a corresponding vehicle manufacturer on the Internet, for example.

Local or remote administration of such service gateway systems is implemented by obligatorily specifying defined interfaces that are needed by the corresponding service gateway to control the applications running on the service gateway in a corresponding specification of requirements for the applications. This means that an application must obligatorily provide a set of defined interfaces to conform to a service gateway on which the applications run. The service gateway and/or corresponding functions and/or functionalities of the service gateway then perform the administration operation by utilizing the interfaces supplied by the applications. In the Open Service Gateway system (OSGI) mentioned above, these include interfaces for installing, uninstalling, initiating, terminating, activating and deactivating a corresponding application, for example. The applications are administered by the service gateway over such interfaces; such administration is also possible remotely by the corresponding gateway operator using the corresponding additional services.

As already mentioned, in the case of remote administration of a service gateway and the applications running on it, it is important to provide a remote diagnosis. Providing a remote diagnosis has been implemented in the past on the basis of a log data file. This means that the service gateway provides a corresponding service, a so-called log service, for all applications running on the service gateway. This service allows the applications running on the service gateway to send messages in the form of a so-called log data file to a central station in the system. There are already approaches using multiple log data files. The messages sent may have any content. For example, they may be messages with regard to status reports while starting the application or version information. Furthermore, it is possible to transmit error reports via such a message. The content of the messages and the point in time when such a method is sent are defined when programming the corresponding application.

Such a log data file, which may contain all types of information, may be queried using appropriate additional services even remotely on the part of the gateway operator. By using a log data file, it is possible to diagnose the system to the extent that the gateway operator is able to analyze the corresponding log data file with regard to information regarding system status and application errors. However, there is no direct communication here between the gateway operator or a diagnostic unit installed in it and the applications running on the corresponding service gateway. Possible information exchange takes place exclusively indirectly via the aforementioned log data file. This means that a gateway operator is unable to access current states of applications running on the corresponding service gateway. Therefore, the values of internal variables are not directly accessible to a gateway operator.

In addition, this does not ensure that a log data file will contain all the information required for a diagnosis, which may be queried and obtained on the part of the gateway operator. This is due to the fact that the log data files are not standardized with regard to content, format or transmission time, and an error message is also not transmitted automatically.

Furthermore, analysis of a log data file is complex because error messages frequently do not stand out, but instead may be concealed between other messages. Therefore, frequent querying of a log data file is associated with a transfer of a large volume of data.

Due to the fact that such a query is usually performed as a wireless transmission via cell phone, this query is also associated with a high cost. Under some circumstances, an analysis may turn out to be complex because in the event of multiple log data files, it is not specified which log data file contains the particular error messages.

Furthermore, the provision of a log service is optional and does not have to be implemented on a system, so that it is not certain whether an error diagnosis is possible.

### SUMMARY OF THE INVENTION

Against this background, the present invention provides a method and a system for supplying internal information, relevant for performing a diagnosis, of an application available in a vehicle and running on a service gateway.

According to an embodiment of the present invention, a method of providing internal information, relevant for performing a diagnosis, of an application available in a vehicle and running on a service gateway is provided, in which a defined uniform application diagnostic interface is provided in the application via which communication with the service gateway is made possible.

In one specific embodiment of the method according to the present invention, specific predefined diagnostic information of the application is automatically supplied via the application diagnostic interface. This unifies and completes the supply of diagnostic information of applications. Furthermore, the supply of diagnostic information by applications may be compelled by predefining this. This procedure facilitates the discovery and elimination of errors.

In another specific embodiment of the method according to the present invention, communication with the service gateway via the application diagnostic interface permits active access to internal diagnosis-relevant states. Such internal diagnosis-relevant states may include, for example, real-time or current data, parameters, configurations and/or error memories of the applications. Access to a configuration may be both reading and writing access, which may be associated with a change in the configuration.

The method according to the present invention minimizes the log data file mentioned above. As a result, system memory space is saved and the quantity of data to be transmitted in the remote query is reduced significantly. This is associated with a cost reduction or cost elimination.

In another embodiment of the method according to the present invention, performance of a diagnosis is initiated via the application diagnostic interface. Performing a diagnosis may be prompted by the application itself or by an external unit.

It is also conceivable for test parameters on the basis of which a self-diagnosis is initiated to be transferred and a result of the self-diagnosis to be communicated via the application diagnostic interface. It is possible for the test parameters to be transferred by an external diagnostic unit which may be situated on a gateway operator, for example, or for them to be made available by an application running on the same service gateway as the corresponding application.

Furthermore, the result of the self-diagnosis may also be communicated to a corresponding external diagnostic unit utilizing the result.

In another specific embodiment of the method according to the present invention, it is also conceivable for a remote diagnosis of the application to be initiated instead of a self-diagnosis which is performed by the application itself. Such a remote diagnosis may be performed by a diagnostic unit set up outside of the service gateway that communicates with the corresponding application over the application diagnostic interface. Such an external diagnostic unit may be linked to the application to be diagnosed indirectly via a diagnostic application running on the same service gateway as the application to be diagnosed.

An application diagnostic interface provided according to the present invention simplifies the implementation of higher-priority diagnostic applications that must access diagnostic information for various applications. Furthermore, such an interface facilitates a remote query of diagnostic information and increases the width and depth of the diagnosis optionally to be performed. The width of a diagnosis refers to the areas included in the diagnosis and the depth of the diagnosis refers to the degree of detail of the diagnosis.

Furthermore, the present invention relates to a system for supplying internal information, relevant for performing a diagnosis, of applications available in a vehicle, the system having at least one application running on a service gateway having a defined uniform application diagnostic interface and at least one diagnostic application capable of communicating with the application via the application diagnostic interface and capable of running on the service gateway, the diagnostic information being able to be supplied and/or retrieved via the application diagnostic interface.

A diagnostic unit located outside of the service gateway with which the diagnostic application is able to communicate via a wireless and/or wired connection is provided in another specific embodiment of the system according to the present invention. This may be, for example, a diagnosis and maintenance server located on a gateway operator. The diagnostic application provided according to the present invention and running on the service gateway is a diagnosis and maintenance application. Such a diagnosis and maintenance application is capable of performing a system diagnosis including diagnostic information retrieved by the application. In general, such a diagnosis and maintenance application may operate locally or with the support of a diagnosis and maintenance server, as indicated above.

In another specific embodiment of the system according to the present invention, performance of a diagnosis may be initiated via the application diagnostic interface. This may be triggered by the particular application itself or initiated by another unit. For example, it is conceivable for a diagnosis and maintenance server located on a gateway operator to initiate a diagnosis of one or more applications via the application diagnostic interface of the corresponding applications.

In addition, the present invention relates to a computer program having a program for performing all the steps of a method according to the present invention when the computer program is executed on a computer or a corresponding computational unit.

The present invention also provides a computer program product having program code which is stored on a computer-readable data medium to perform a method according to the present invention when the computer program is executed on a computer or a corresponding computational unit.

### BRIEF DESCRIPTION OF THE DRAWING

FIG. 1 shows a schematic diagram of one embodiment of a system according to the present invention.

### DETAILED DESCRIPTION

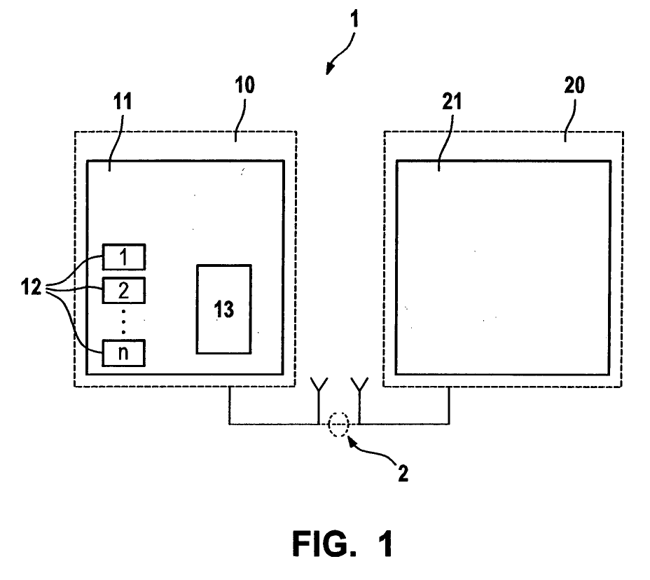

FIG. 1 shows a system 1 for supplying internal information, relevant for performing a diagnosis, of applications available in a vehicle. System 1 includes a service gateway 10 and a gateway operator 20. Service gateway 10 is linked to gateway operator 20 via a wireless or wired connection 2 and forms a service gateway system together with gateway operator 20.

In addition to other units not shown here, gateway operator 20 includes a diagnosis and maintenance server 21. Service gateway 10 has a framework 11. A plurality of applications 1 through n run on framework 11. All of these applications have an application diagnostic interface 12. Furthermore, framework 11 includes a diagnosis and maintenance application 13. Diagnosis application 13 may now communicate directly with applications 1 through n via their application diagnostic interface 12. A user of service gateway 10 or a user from the outside may then initiate a diagnosis via diagnosis and maintenance application 13.

Furthermore, it is also conceivable for each application 1 through n to use an error management system provided on diagnosis and maintenance application 13 in the event of an error and thereby to trigger a diagnostic procedure.

After initiating such a diagnostic procedure, a connection to diagnosis and maintenance server 21, which is on gateway operator 20, is established via diagnosis and maintenance application 13. Diagnosis and maintenance server 21 requests diagnostic information for applications 1 through n that are to be diagnosed via diagnosis and maintenance application 13. Diagnosis and maintenance application 13 retrieves this diagnostic information via application diagnostic interface 12 of the corresponding applications to be diagnosed. If necessary, the diagnostic information retrieved in this way is processed by diagnosis and maintenance application 13 and then forwarded to diagnosis and maintenance server 21.

In another step, diagnosis and maintenance server 21 transmits test parameters to diagnosis and maintenance application 13. Diagnosis and maintenance application 13 forwards these test parameters via application diagnostic interface 12 to the application to be diagnosed.

After the application to be diagnosed has performed a self-test with the help of the test parameters, the results of this self-diagnosis are sent via application diagnostic interface 12 to diagnosis and maintenance application 13, from which they are sent further to diagnosis and maintenance server 21. Diagnosis and maintenance server 21 may supplement the diagnostic capabilities of diagnosis and maintenance application 13. Diagnosis and maintenance server 21 has a scope of functions that depends on the capabilities of connected diagnosis and maintenance application 13. Various types of scaling are conceivable here. In the case of an intelligent diagnosis and maintenance application 13, diagnosis and maintenance server 21 is automatically reduced to a remote query, for example.

Application diagnostic interface 12 contains methods for allowing access to the internal data of an application to be diagnosed or framework 11 of a service gateway 10. Another method allows a self-diagnosis to be initiated. For simple and uncomplicated processing of test parameters and the corresponding feedback values in the form of a result, a uniform data type that allows structures and nesting is advantageously used. In an implementation with Java, this might be, for example, java.util.Map. Furthermore, a general data type may be used for the lowest level of nesting, which might be java.lang.String, for example, in the case of an implementation with Java. In addition, when calling up a method, an object may be transferred for authorization, thus preventing unauthorized execution of the individual methods.

When using the application diagnostic interface according to the present invention as part of an Open Service Gateway system as mentioned in the introduction, for example according to the aforementioned OSGi standard, it is possible to specify the application diagnostic interface as part of a platform specification as part of the open standard, i.e., by driving the standardization operation. However, it is also conceivable to specify the application diagnostic interface according to the present invention in the form of a proprietary addition to a corresponding standard.

The application diagnostic interface according to the present invention might be executed as follows, for example:

/**
*Interface to be implemented by diagnosable Application. *The interface provides
methods to get information upon *the inside states, configuration, known errors, ... of
the *Application.
*/
public interface IDiagnosis{
/**
*Gets necessary information for diagnosis.
*@param actor The user identification object to enable *restricted operation
*during/for the collection of diagnosis data
*@return For diagnosis necessary data like parameter, *properties, internal states,
*known errors, internal configurations and other important *information. The data can
be structured into folders and *subfolders.
*NULL indicates an error at creation for the diagnosis *data.
*/
public Map getDiagnosisData (Authorisation actor);
/**
*Gets returnvalues out of an internal selftest by the *Application
*@param testParam The test parameter which are to run the *selftest.
*@param actor The user identification object to enable *restricted operation
*during/for the collection of diagnosis data
*@return For diagnosis necessary data like parameter, *properties, internal states,
*known errors, internal configurations and other important *information. The data can
be structured into folders and *subfolders.
*NULL indicates an error at creation for the diagnosis *data.
*/
public Map selftest (Map testParam, Authorisation actor)

1-12. (canceled)

13. A method for supplying internal information, relevant for performing a diagnosis, of an application available in a vehicle and running on a service gateway, the method comprising:
providing a defined uniform application diagnostic interface, via which communication with the service gateway is made possible, in the application.

14. The method according to claim 13, wherein specific predefined diagnostic information of the application is automatically supplied via the application diagnostic interface.

15. The method according to claim 13, wherein the communication with the service gateway via the application diagnostic interface allows active access to internal states relevant to the diagnosis.

16. The method according to claim 15, wherein access to at least one of real-time data, parameters, configurations and error memories of the application is made possible.

17. The method according to claim 13, wherein the performance of a diagnosis is initiated via the application diagnostic interface.

18. The method according to claim 17, wherein test parameters, on the basis of which a self-diagnosis is initiated, are transmitted, and a result of the self-diagnosis is communicated via the application diagnostic interface.

19. The method according to claim 17, wherein a remote diagnosis of the application is initiated via the application diagnostic interface.

20. A system for supplying internal information, relevant for performing a diagnosis, of an application available in a vehicle, the system comprising:
at least one application running on a service gateway;
a defined uniform application diagnostic interface; and
at least one diagnostic application running on the service gateway and capable of communicating with the application via the application diagnostic interface,
wherein diagnostic information is at least one of suppliable and retrievable via the application diagnostic interface.

21. The system according to claim 20, further comprising a diagnostic unit situated outside of the service gateway, with which the diagnostic application is able to communicate via at least one of a wireless and wired connection.

22. The system according to claim 20, wherein a performance of a diagnosis is initiated via the application diagnostic interface.

23. A computer-readable medium containing a computer program which when executed by a processor performs the following method for supplying internal information, relevant for performing a diagnosis, of an application available in a vehicle and running on a service gateway:
providing a defined uniform application diagnostic interface, via which communication with the service gateway is made possible, in the application.
